(19) United States
(12) Patent Application Publication
(10) Pub. No.: US 2021/0102032 A1
(43) Pub. Date: Apr. 8, 2021

(54) REINFORCED THERMOSETTING COMPOSITE MATERIAL

(71) Applicant: Jorge GREEN, Porto Allegre - RS (BR)

(72) Inventor: Jorge GREEN, Porto Allegre - RS (BR)

(21) Appl. No.: 15/733,507

(22) PCT Filed: Feb. 12, 2019
(86) PCT No.: PCT/BR2019/050042

§ 371 Date: Aug. 14, 2020

(30) Foreign Application Priority Data
Feb. 16, 2018 (BR) B10 2018 003060.4

(51) Int. Cl. C08J 5/04; C08K 11/00

(52) U.S. Cl. CPC C08J 5/043; C08K 2201/004; C08J 2367/00; C08K 11/005

(57) ABSTRACT

The invention relates to a reinforced thermosetting composite, characterized in that it comprises sand, inert powder, thermosetting resin and fibers, a novel composition that enables advances to be made in relation to the prior art, allowing planners and constructors to implement their projects with alternatives that are more advanced and affordable than existing ones. This composite is totally impermeable, with a lower specific weight than cement concrete, and high compressive strength and tensile strength. It does not oxidize like iron or steel and is highly durable in terms of weather-resistance. Furthermore, important waste is used in the formulation of the composite, but no water, and the composite is sustainable as it can be recycled to produce new parts, and as such is eco-friendly.

### FIELD OF THE INVENTION

The present invention is related to a novel thermosetting composite material comprising a mixture having a specific combination of sand, fine powder, one or more resins and synthetic, metallic, natural fibers or mixtures thereof.

In the context of the present invention, the term composite means any type of material having a composition including at least two or more materials known and formulated in a particular, specific and suitable way, aimed at a predetermined application.

### STATE OF THE ART

As is well known, great advances are being made in technologies aimed at meeting human needs and seeking the creation of new materials, as well as the combination of existing materials to satisfy new feasibility requirements for modern projects in a number of areas, mainly in industries and civil construction. This technological advance fully justifies the creation and existence of new composite materials.

As a rule, for its manufacturing, a composite material requires a binding element in its composition, that allows mixing the components, usually through a chemical reaction or through heat, between them or only one of them, originating a fusion or union of the components of the mixture, thus forming a single compound, of rigid, or malleable, or flexible features. In general, the binder may be thermoplastic or thermosetting.

When the thermoplastic binder is used, application of heat tends to change its shape and features, melting or flowing. When the thermosetting binder is used, its shape and features are maintained after curing, even at high temperatures.

The current state of the art allows us to notice the existence of thermoplastic composites and thermosetting composites with differentiated compositions and production processes.

The vast majority of composites in the state of the art is produced by pultrusion processes. This process produces continuous composite profiles constituted by a thermosetting resins matrix and reinforcement components, in general fibers. The process consists in pulling the fibers and impregnating them in the resins matrix through a die or mold. Then, the die or mold is subjected to heating, causing the resin to harden or cure in polymerization process. The process requires accurate temperature control, which is essential for obtaining uniform properties in the final product. Particular features of the mold allow for obtaining a specific profile geometry, as well as the desired surface finish. Despite its widespread use, the pultrusion process has proven itself to be quite sophisticated and of slow production, thus raising the cost of the product to a higher level.

Another thermosetting composite material comprising polyester resin, sand, and ashes is the subject of Brazilian patent application P10403092-3 by the same inventor. The composite material that is related in said document is used in the manufacture of pre-molded products, but due to its performance limitations in view of newer technological requirements in the market, this material proved to be somewhat inefficient, and should therefore be improved to meet the current demand.

Therefore, it is the objective of the present invention to provide a new composite material composition that allows, due to its new features, enormous gains related to increasing conditions for facing technical solutions and performance in current requirements, which was not possible with the state of the art.

It is a further objective of the present invention to produce a thermosetting composite material provided by a process of mixing all elements in a suitable mixer, and, after prepared, said mixture is discharged into a mold previously made for operations of pressing and fast curing of the mixture. Thus, according to the present invention, pre-molded composite material parts are produced with high productivity and involving simple and automated operations.

### DESCRIPTION OF THE INVENTION

The reinforced thermosetting composite material according to the present invention is defined as a composition comprising sand, fine powder, thermosetting resin and fibers.

More specifically, the reinforced composite material according to the present invention comprises a mixture, in percentage by weight, of about 30-50% of sand, about 15-30% of inert fine powder, about 20-30% of resin of thermosetting resin, about 4-10% of fibers.

Typically, one or more thermosetting resins can be used, but when only one is used, it is preferably rigid or flexible polyester.

The fibers used in the reinforced composite material according to the present invention can be metallic, carbon, glass or natural fibers, or mixtures thereof, among others as long as compatible with the other components of the reinforced composite material according to the present invention.

Preferably, glass fiber is used and, when used, it is preferably in the thread segments form.

A preferred formulation example of the reinforced composite material according to the present invention comprises a mixture, in percentage by weight, of about 50% of dry sand, about 20% of dry mineral coal ashes, about 25% of resin of thermosetting resin, about 5% of fibers.

A percentage of about 5% by weight of fibers seems low, but as usually said fibers have low specific weight, their volume is significant in the final product.

In the mixture of components of the reinforced composite material according to the present invention, a suitable mixer should be used, since the fibers will be in the form of short length threads, usually ranging from 2 to 10 cm, and the mass becomes quite consistent with gradual addition of said glass fibers. It can be considered that it is a “heavy mass” that must be mixed properly. Typically, a Sigma type mixer is used, not excluding others.

The thermosetting resin is preferably pre-accelerated and its catalyzing process, that is, the hardening reaction, is initiated as soon as components are mixed in the mixer, for a period of time sufficient to prepare the mixture and then transfer it to the mold for later pressing.

Alternatively, the mixture of components can be subjected to injection molding processes.

Also, with the use of fibers in the composite material, it is possible to obtain greater mechanical strengths, not only related to compression, but mainly tensile strength of the molded product. If there were no such fibers, the bond strength between the composition materials would depend exclusively on the resin anchored with the sand. As opposed to that, by employing fibers according to the present invention, said anchorage becomes a trinomial based on sand, resin and fibers, enabling greater strengths, mainly tensile strength, since the fibers will also be spread horizontally along the body of the part produced.

In addition, the reinforced composite material according to the present invention is eco-friendly, as it does not employ water in its composition, but rather important industrial waste, such as ashes from the burning of mineral coal or ore powder waste, such as gravel powder, among others. Additionally, it is sustainable, since instead of being discarded after any type of use, if applicable, it can be crushed and reused in the production process of new parts.

Thus, it is apparent to a person skilled in the art that pre-molded products manufactured with the reinforced composite material object of the present invention will be much stronger, and project leads may enjoy advantages in reduced dimensions, weight and costs in their projects, which cannot be achieved by other existing or proposed products on the market. It is especially suitable for various applications, and can be useful in replacing cement concrete in buildings, wooden crossties on railroads, wood and glass in furniture and utensils, among other numerous applications, since it is totally impermeable, has low specific weight, high compressive strength and tensile strength, does not oxidize like iron and steel and is highly durable exposed to weather.

1. A reinforced thermosetting composite material, characterized by comprising a mixture of, in percentage by weight, about 30-50% of sand, about 15-30% of fine inert powder, about 20-30% of resin of thermosetting resin, about 4-10% of fibers.

2. The reinforced thermosetting composite material according to claim 1, characterized in that one or more thermosetting resins are used.

3. The reinforced thermosetting composite material according to claim 2, characterized in that the resin is rigid or flexible polyester.

4. The reinforced thermosetting composite material according to claim 1, characterized in that the fibers are of the metallic, carbon, glass or natural type, or mixtures thereof.

5. The reinforced thermosetting composite material according to claim 1 or 4, characterized in that the fibers are in the thread segments form ranging in length from about 2-10.

6. A reinforced thermosetting composite material comprised of sand, fine powder, polyester resin, characterized by employing fibers with the objective of increasing its mechanical characteristics.

7. The reinforced thermosetting composite material according to claim 4, characterized in that the fiber is glass fiber.

8. The reinforced thermosetting composite material according to claim 1, characterized in that the inert fine powder is ashes from the burning of mineral coal, ore powder waste or gravel powder.

9. The reinforced thermosetting composite material according to any one of claims 1 to 7, characterized in that it comprises a mixture, in percentage by weight, of about 50% of dry sand, about 20% of dry mineral coal ashes, about 25% of resin of thermosetting resin, about 5% of fibers.
